(19) United States
(12) Patent Application Publication
(10) Pub. No.: US 2023/0046453 A1
(43) Pub. Date: Feb. 16, 2023

(54) ONE-PIECE CLAMP ASSEMBLY FOR WINDOW COVERING

(71) Applicants: Jeffrey David WILLIAMS, Sarnia (CA); Thai NGUYEN, Georgetown (CA); Mingxuan WANG, Milton (CA); Angela TOLLIS, Hamilton (CA); Joyce CHEN, Toronto (CA)

(72) Inventors: Jeffrey David WILLIAMS, Sarnia (CA); Thai NGUYEN, Georgetown (CA); Mingxuan WANG, Milton (CA); Angela TOLLIS, Hamilton (CA); Joyce CHEN, Toronto (CA)

(73) Assignee: Huron Shores Productions Inc., Sarnia (CA)

(21) Appl. No.: 17/885,996

(22) Filed: Aug. 11, 2022

Related U.S. Application Data
(60) Provisional application No. 63/231,943, filed on Aug. 11, 2021.

(51) Int. Cl. E06B 9/36; E06B 9/388

(52) U.S. Cl. CPC E06B 9/367; E06B 9/388; B33Y 80/00

(57) ABSTRACT

A one-piece clamp assembly for a window covering is disclosed. The window covering consists of a left side portion and right side portion connected to a moveable hinge portion. The left side portion comprises a plurality of rounded extrusions and at least one vertical rounded extrusion that securely mates into a hole or slot on the right side portion. The left side portion further comprises extruded walls that mate with single and double spikes found on the right side portion. The extruded portions and mating spikes provide for a secure connection of the clamp assembly to the window covering. A connecting slot is placed on either the left or ride side portion, enabling the clamp assembly to fasten to a head rail fastener of a window covering.

### CROSS REFERENCE TO RELATED APPLICATIONS

The application claims priority to and the benefit of U.S. Pat. Application Serial No. 63/231943, entitled “ONE PIECE CLAMP ASSEMBLY FOR WINDOW COVERING”, filed on Aug. 11, 2021, the disclosure of which is incorporated herein by reference in its entirety.

### BACKGROUND

The embodiments described herein relate to window covering assemblies, in particular, technologies related to securing a window covering portion to a headrail portion of a window covering assembly.

There are many different types of window coverings and treatments for use in covering windows of all shapes, sizes, and locations. Typically, window covering assemblies include an actual window covering portion, and a headrail preferably operable to allow manipulation of the window covering portion. For example, window coverings generally allow for the selective covering and uncovering of a window, as well as intermediate positions there between.

Window coverings include curtains and vertical blind panes and may be made out of fabric, plastic, vinyl or similar materials. These window coverings may be attached to a headrail portion by a clamp or clamp assembly. The clamp or clamp assembly connects to the window covering at one end (i.e., bottom portion) and the headrail portion on the other end (i.e., top portion) and allows the window covering to slide along the headrail.

The clamp or clamp assembly is typically made of two pieces out of plastic or metal. The clamp assembly also comprises a clamping mechanism to securely connect to the window covering. The clamping mechanism may include one uniform securing mechanism (e.g., one type used) including teeth, a nut and bolt design, fasteners and Velcro®. However, some of these uniform securing mechanisms may not provide a secure connection (e.g., window coverings may be loose and get de-attached) and may be difficult to install on either the window covering or on the headrail portion.

There is a desire for a clamp assembly that provides a better securing mechanism for the window covering. There is a further desire for a one-piece clamp assembly made of one uniform material.

### SUMMARY

A one-piece clamp assembly for a window covering is disclosed. The window covering consists of a left side portion and a right side portion connected to a moveable hinge portion. The left side portion comprises a plurality of rounded extrusions and at least one vertical rounded extrusion that securely mates into holes or slots on the right side portion. The left side portion further comprises extruded walls that mate with single and double spikes found on the right side portion. The extruded portions and mating spikes provide for a secure connection of the clamp assembly to the window covering. A connecting slot is placed on either the left or right side portion, enabling the clamp assembly to fasten to a head rail fastener of a window covering.

### BRIEF DESCRIPTION OF THE DRAWINGS

FIG. 1 is a diagram illustrating a perspective view of a one-piece clamp assembly in a closed position.

FIG. 2 is a diagram illustrating a perspective view of a one-piece clamp assembly in an open position.

FIG. 3 is a diagram illustrating a top plan view of a one-piece clamp assembly in an open position.

FIGS. 4A to 4C are diagrams illustrating a perspective view of a one-piece clamp assembly with separated side portions.

FIGS. 5A to 5C are diagrams illustrating side views of the alternate one-piece clamp assembly as shown in FIG. 2.

FIG. 6 is a close-up view of the one-piece clamp assembly in a closed position.

FIG. 7 is a close-up view of the one-piece clamp assembly in an open position. FIG. 8 is a diagram illustrating a perspective view of an alternate embodiment of the one-piece clamp assembly with dimensions.

FIGS. 9A and 9B are diagrams illustrating perspective views of the left and right side portions of the alternate one-piece clamp assembly.

FIG. 10 is a line drawing illustrating a perspective view of clamp assemblies on a window covering.

FIG. 11 is a line drawing illustrating a side view of the window covering as seen in FIG. 10.

FIGS. 12A, 12B and 12C are further diagrams illustrating clamp assemblies on a window covering in a straight alignment.

FIG. 13 is a line drawing illustrating a perspective view of clamp assemblies on a window covering in an angled alignment.

FIG. 14 is a diagram illustrating a side view of the window covering as seen in FIG. 13.

FIGS. 15A, 15B and 15C are further diagrams illustrating clamp assemblies on a window covering in an angled alignment.

FIG. 16 is a diagram depicting a window covering using the clamp assembly.

### DETAILED DESCRIPTION

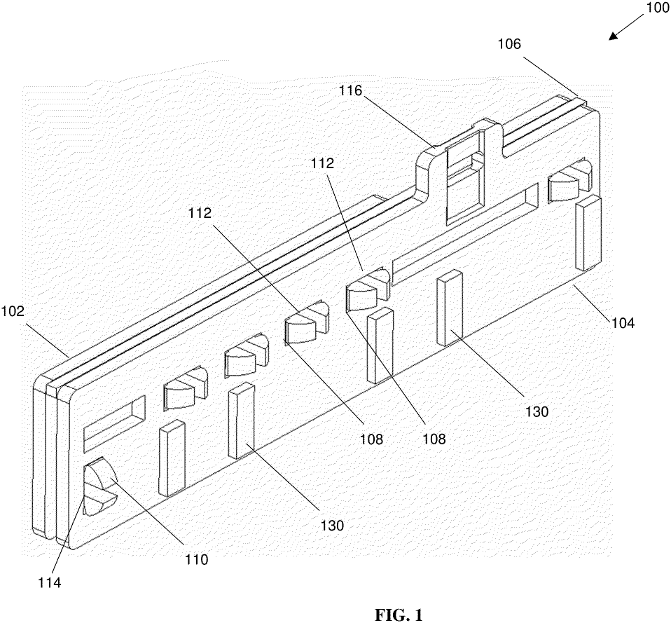

FIG. 1 is a diagram illustrating a perspective view of a one-piece clamp assembly in a closed position. According to FIG. 1, a one-piece clamp assembly 100 for a window covering consists of a left side portion 102 and a right side portion 104 connected by a hinge portion 106. On one of the side portions (e.g., left side portion 102) a plurality of rounded extrusions 108 (e.g., two or more) exist with an additional rounded extrusion 110 on the vertical side plane which have a hollowed centre to allow for a slight bend when securing on the opposite side’s through-holes. These rounded extrusions 108 will fit through a connecting hole 112 and 114 on the other side portion (e.g., right side portion 104), providing a securing connection. One of the side portions (e.g., right side portion 104, but can also be on the left side portion 102) comprises a connecting slot 116 to enable the clamp assembly to fasten to a head rail fastener.

According to FIG. 1, the one-piece clamp assembly 100 further comprises rounded outer edges for a smoother outer surface design. Furthermore, the clamp assembly is a single part with a hinge design and can be manufactured via injection molding or 3-D printing.

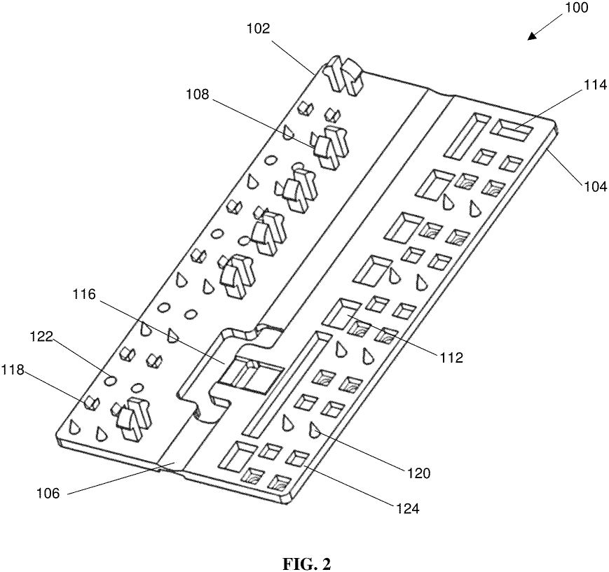

According to FIG. 1, the one-piece clamp assembly 100 further comprises a plurality of protrusions 130 on the right side portion 104. Protrusions 130 provide depth for extruded channels 124 (shown in FIG. 2) on the other side of right side portion 104.

FIG. 2 is a diagram illustrating a perspective view of a one-piece clamp assembly in an open position. According to FIG. 2, the one-piece clamp assembly 100 is in an open position having a left side portion 102, right side portion 104 and a connecting hinge 106 all placed in one plane (e.g., in open position). The left side portion 102 comprises four horizontal rounded extrusions and one vertical rounded extrusion 108. The left side portion 102 also comprises a plurality of extruded walls 118 (e.g., square shapes) placed throughout the left side portion 102 that mates with a reciprocal extruded channel 124 on right side portion 104. The extruded walls 118 act as security points to enable a secure connection. The rounded extrusions 108 are “U” shaped with a slight bend to enable further secure connection.

According to FIG. 2, the one-piece clamp assembly 100 further comprises a right side portion 104 having holes 112 (or slots) to accept the rounded extrusions 108 and an alternate design of single and double spikes 120 acting as security points to hold the window covering (e.g., fabric blinds or vertical blinds). The alternating single and double spikes 120 mate with the extruded walls 118 and spike holes 122 on the opposite side portion (i.e., left side portion 102) providing alternating pressure points for a secure connection.

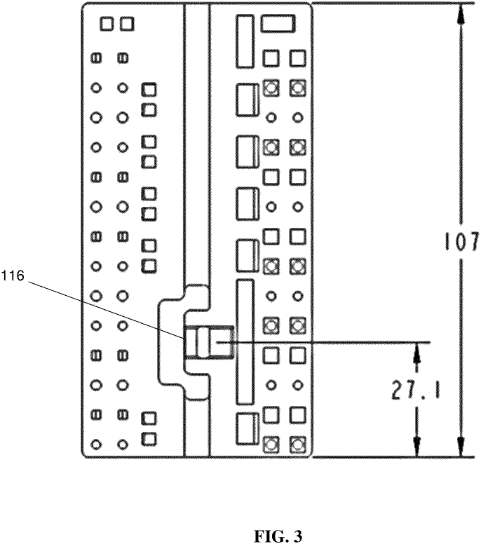

FIG. 3 is a diagram illustrating a top plan view of a one-piece clamp assembly in an open position. According to FIG. 3, the length of the one-piece clamp assembly is 107 mm and connecting slot 116 is 27.1 mm from the bottom edge.

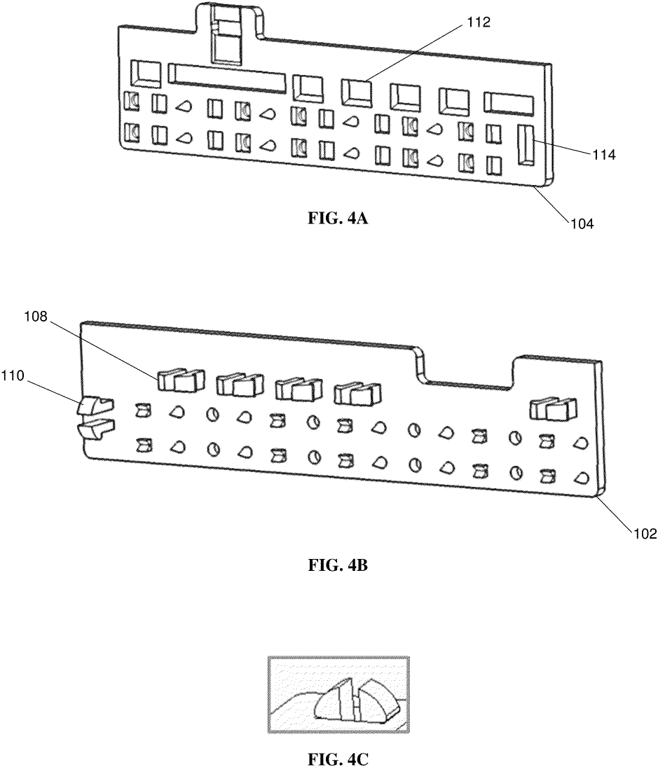

FIGS. 4A to 4C are diagrams illustrating a perspective view of a one-piece clamp assembly with separated side portions. FIG. 4A is a diagram of the left side portion of the one-piece clamp assembly. FIG. 3B is a diagram of right side portion of the one-piece clamp assembly. According to FIG. 4B, rounded extrusions 108 and 110 are shown having a left and right leg and a notch. When pinched or inserted in connecting holes 112 and 114, the left and right leg will touch and form a rounded extrusion, creating a secure connection. FIG. 4C is a diagram illustrating a rounded extrusion inserted into its respective hole to provide a secure connection.

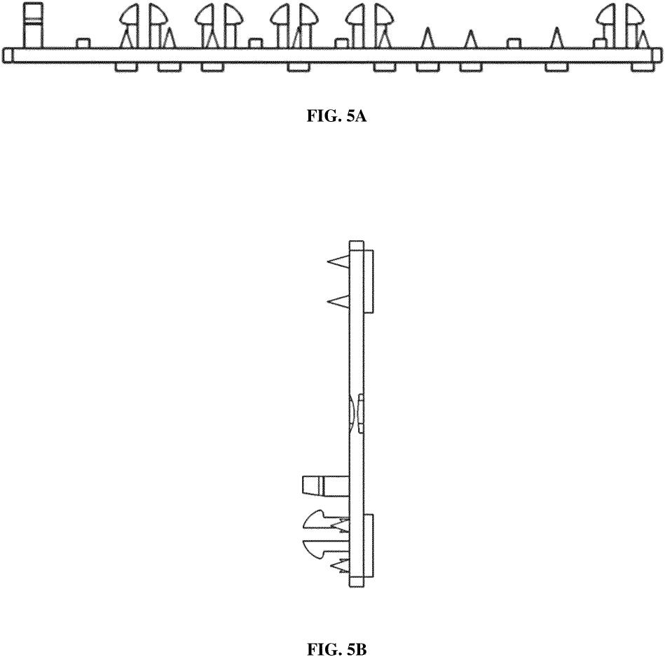

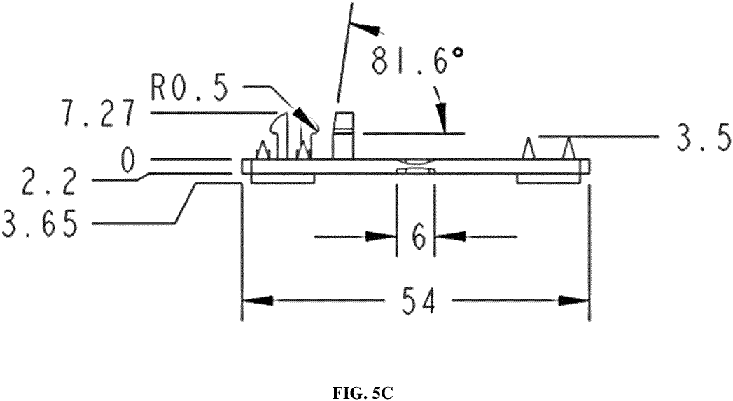

FIGS. 5A to 5C are diagrams illustrating side views of the one-piece clamp assembly as shown in FIG. 2. FIG. 5A is a horizontal left side view of the one-piece clamp assembly. FIG. 5B is a vertical right side view of the one-piece clamp assembly.

FIG. 5C is a horizontal front side view of the one-piece clamp assembly. According to FIG. 5C, dimensions of each component are shown in millimeters (mm). According to FIG. 5C, the openings were enlarged and slanted to aid the path of the clip snapping or large vertical rounded extrusions. The clip or extrusion is rounded by 0.5 mm. The clips are also slanted in one direction and the radius is increased by 1.15 mm for the spikes.

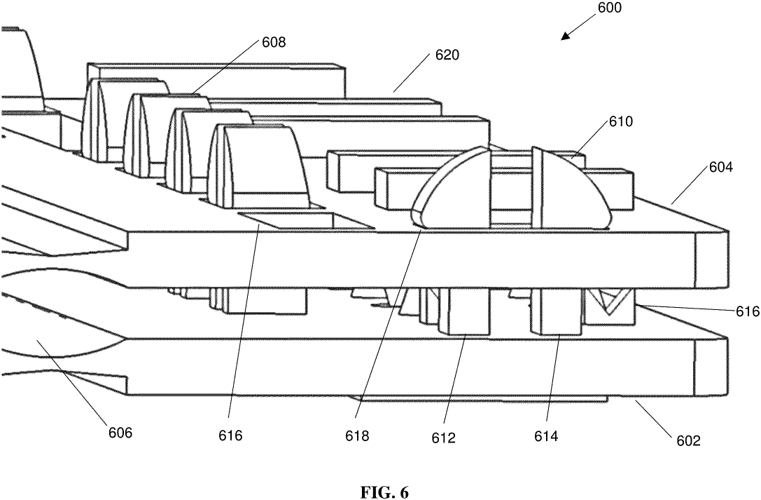

FIG. 6 is a close-up view of the one-piece clamp assembly in a closed position. According to FIG. 6, one-piece clamp assembly 600 comprises a left side portion 602 and right side portion 604, is folded over at hinge 606 into a closed position. A plurality of horizontal rounded extrusions 608 are threaded through securing slot 616. A large vertical rounded extrusion 610 is also threaded through a larger securing slot 618. Large vertical rounded extrusion 610 further comprises a left arm 612 and right arm 614 with a rounded head and have a height of approximately 7.27 mm. When pinched together, the left arm 612 and right arm 614 form a rounded extrusion head.

According to FIG. 6, the left side portion 602 further comprises a plurality of spikes 616 that mates or connects to a receiving channel (not shown) on right side portion 604. Right side portion also has a plurality of protrusions 620 on the opposite side of right side portion 604. Vertical bar 620 acts as a securing mechanism for the spikes. When in a clamped or folded position there is a gap of approximately 2 mm that can receive thicker window blind or curtain material.

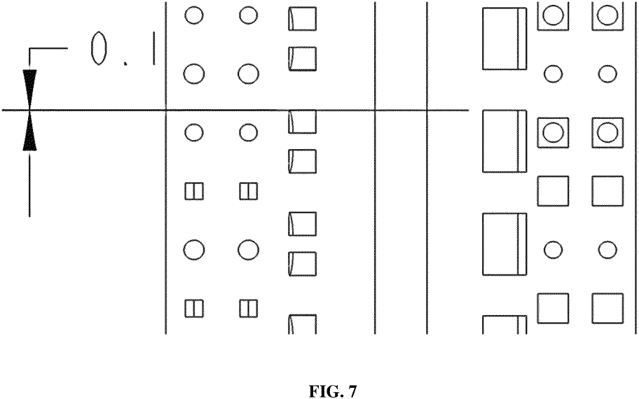

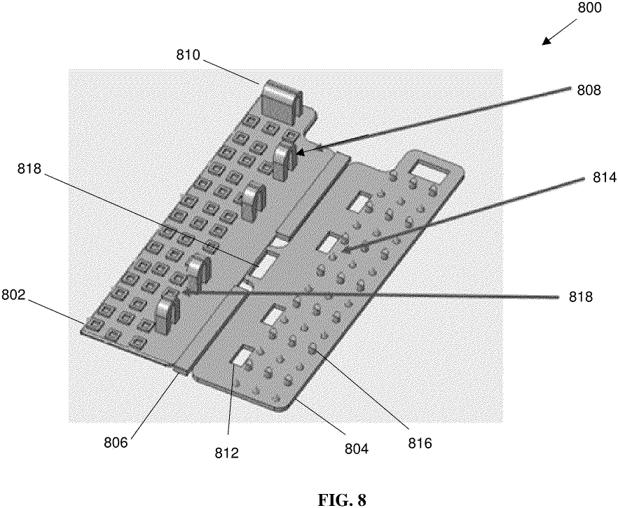

FIG. 7 is a close-up view of the one-piece clamp assembly in an open position. According to FIG. 7, the interference of the spike (or snap) and the hole is approximately 0.1 mm. In further embodiments, the interference width can be adjusted to ensure a more secure fit.

FIG. 8 is a diagram illustrating a perspective view of an alternate one-piece clamp assembly in an open position. According to FIG. 8, a singular part clamp assembly 800 is shown having two clipping side portions (e.g., left side portion 802 and right side portion 804) connected by a living hinge 806 joining the two side portions permitting movement. The singular part clamp assembly 800 can be made of a clear, polished polycarbonate material and can be manufactured by injection molding and / or 3D printing techniques.

According to FIG. 8, the left side portion 802 has a plurality of horizontal rounded extrusions 808 and at least one vertical rounded extrusion 810. The rounded extrusions 808 and 810 are “U”-shaped with a rounded lip that extrudes from the connecting slot 812 on the right side portion 804. The right side portion 804 also comprises an alternate pattern of single spikes 814 and double spikes 816 arranged in alternating rows and columns. The left side portion 802 also consist of divots (or divot holes) 818 for receiving spikes 814 and 816 from the right side portion 804. Spikes 814 and 816 form alternating pressure points that are received in extruded walls 818 for a secure connection.

According to FIG. 8, the right side portion 804 comprises rounded extrusion holes 812 for receiving the rounded extrusions 808 from the left side portion 802. The right side portion 804 further comprises extruded walls 818 to secure the clamp assembly 800 to a head rail fastener of a curtain (not shown). In further embodiments, the securing slot 818 alternatively can be placed on the left side portion.

According to FIG. 8, the dimensions of the alternate one-piece clamp assembly are as follow:
Outer Dimensions: 107x64x2.2 mm
Total Surface Area: 13, 282.5 mm²
Total Volume: 11,050.2 mm³
Spike Dimensions: 2x3.5 mm
Square Spike Dimensions: 2x2x1.55 mm
Clip Dimensions: 7.85x6.1 mm
Indentation: Bending Living Hinge at Centre (99x4x1 mm)

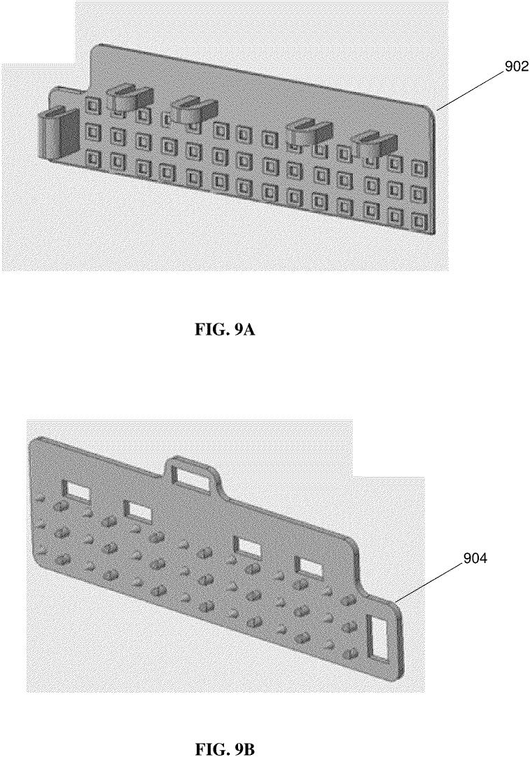

FIGS. 9A and 9B are diagrams illustrating perspective views of the left and right side portions of the alternate one-piece clamp assembly. FIG. 9A is diagram of left side portion 902. FIG. 9B is diagram of right side portion 904.

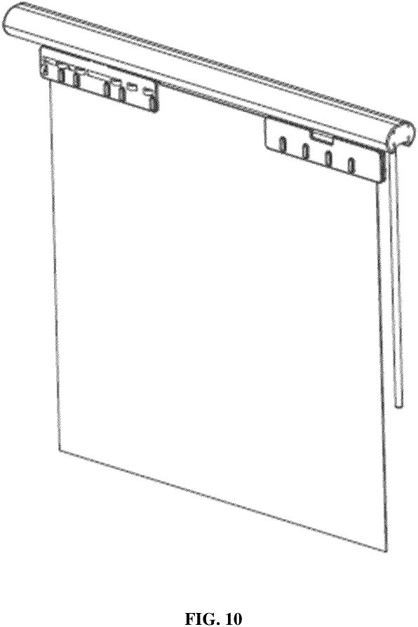

FIG. 10 is a line drawing illustrating a perspective view of clamp assemblies on a window covering in a straight alignment. According to FIG. 10, a window covering (e.g., vertical blind) is shown secured by two clamp assemblies in a straight alignment. The clamp assemblies are then securely fastened to a head rail. A vertical bar is also shown to guide the window covering along the head rail.

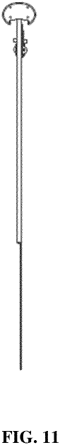

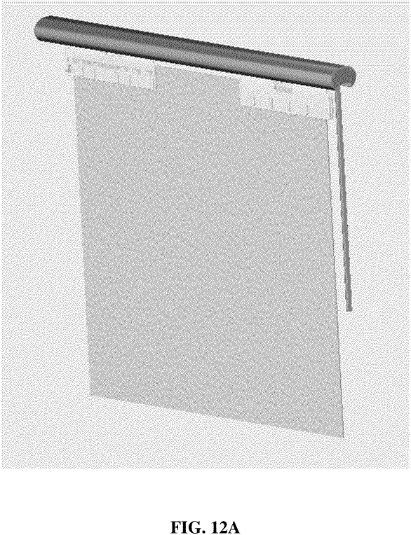

FIG. 11 is a line drawing illustrating a side view of the window covering as seen in FIG. 10.

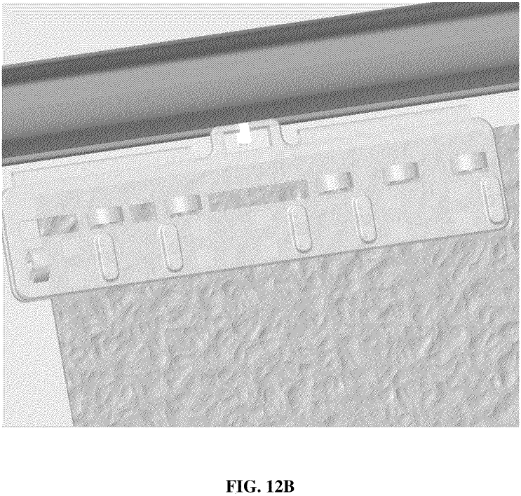

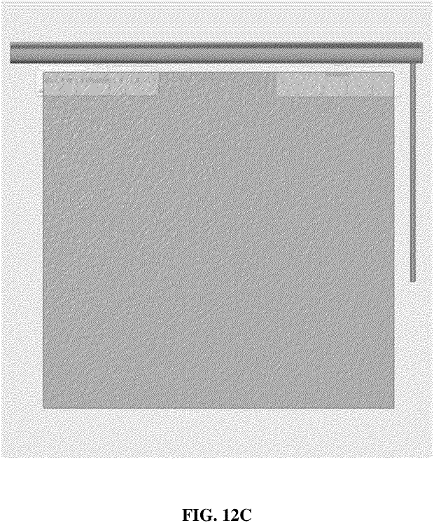

FIGS. 12A, 12B and 12C are further diagrams illustrating clamp assemblies on a window covering in a straight alignment. According to FIGS. 12A to 12C, the clamp assemblies are shown to cover the top edge of the fabric of the window covering.

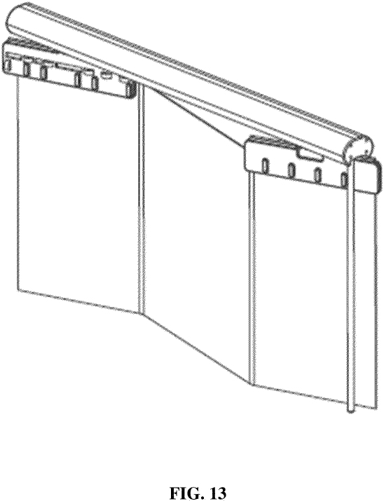

FIG. 13 is a line drawing illustrating a perspective view of clamp assemblies on a window covering in an angled alignment. According to FIG. 13, a window covering (e.g., vertical blind or curtain) is shown secured by two clamp assemblies in an angled alignment. The clamp assemblies are then securely fastened to a head rail. The window cover is shown to be in a slightly folded position (or angled). As shown in FIG. 13, the clamp assembly enables the window covering to pivot and move from a fully open to a fully closed position. A vertical bar is also shown to guide the window covering along the head rail.

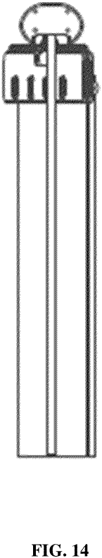

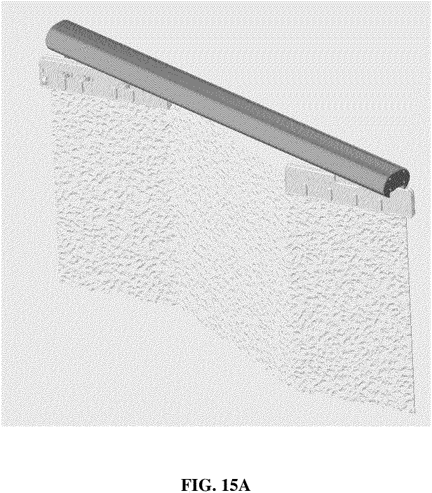

FIG. 14 is a line drawing illustrating a side view of the window covering as seen in FIG. 13.

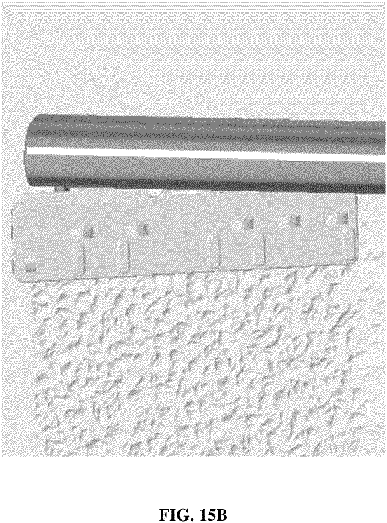

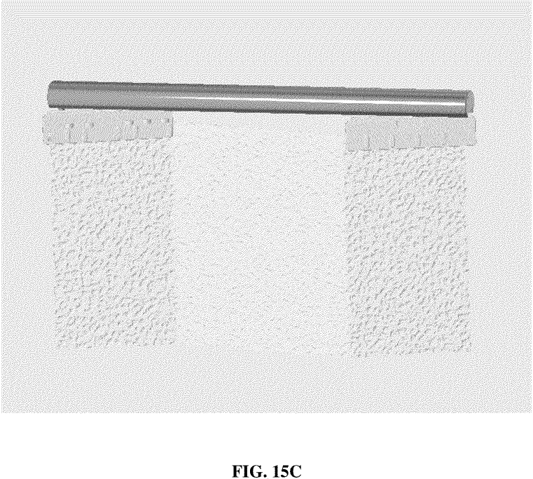

FIGS. 15A, 15B and 15C are further diagrams illustrating clamp assemblies on a window covering in an angled alignment. According to FIGS. 15A to 15C, the clamp assemblies are shown to cover the top edge of the fabric of the window covering.

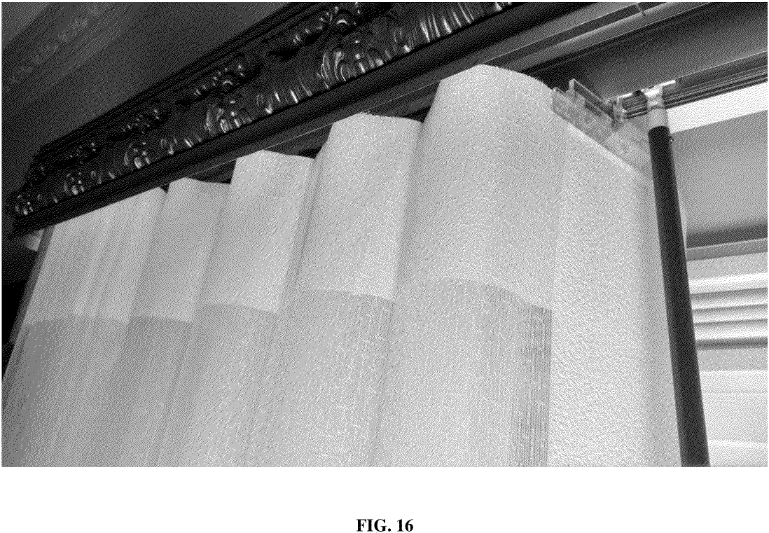

FIG. 16 is a photograph depicting a window covering using the clamp assembly. As seen in FIG. 16, a clamp assembly is shown connected to a curtain. The clamp assembly is also securely connected to the head rail. A vertical bar is also shown to guide the window covering along the head rail.

The proposed embodiment discusses window coverings, however, the proposed disclosure can be extended to be used to cover patio doors or regular doors or openings. The proposed disclosure may also be used with rigid or semi-rigid doors or folding doors (such as accordion-folding doors or bi-fold doors) or other uses such as with shower curtains.

According to the disclosure, the clamp assembly can be made of metal or plastic such as polypropylene. The mold of the clamp can be made of aluminum or steel. According to further embodiments, the single hinge design may also incorporate a two-part hinge such as a barrel hinge, spring-loaded butt hinge, plastic hinge, or piano style hinge. A two-part hinge (e.g., hinge used to hang a door frame) may incorporate a pin in the middle for rotation and may require assembly before use.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A one-piece clamp assembly for securing a window covering comprising:
a left side portion further comprising:
a plurality of rounded extrusions;
a plurality of spikes;
a plurality of extruded walls; and
a plurality of spike holes;
a right side portion further comprising;
a plurality of connecting holes to receive the rounded extrusions from the left side portion;
a plurality of spike holes to receive the spikes from the left side portion;
a plurality of receiving channels to receive the extruded walls of the left side portion; and
a plurality of spikes to engage with the spike holes of the left side portion; and
a hinge portion connecting the left side portion and right side portion;
wherein the one-piece clamp assembly is made of a one-piece material;
wherein the one-piece clamp assembly is configured to be in an open position and a closed position;
wherein in the closed position, the rounded extrusions mate with the connecting holes, the extruded walls mate with the extruded channels and the spikes mate with the spike holes to form a secure connection, whereby the window covering is secured therein between the left side portion and the right side portion.

2. The clamp assembly of claim 1 wherein the plurality of rounded extrusions further comprises a horizontal extrusion and a larger vertical extrusion.

3. The clamp assembly of claim 2 wherein the plurality of rounded extrusions further comprises a left and right leg and a rounded head such that, when pinched, the head creates a rounded extrusion.

4. The clamp assembly of claim 1 wherein the window covering is a window curtain or a vertical blind.

5. The clamp assembly of claim 1 wherein the hinge portion further comprises a connecting slot configured to fasten the clamp assembly to a head rail fastener of the window covering.

6. The clamp assembly of claim 1, made from a single material selected from a list consisting of aluminum, steel, polypropylene and plastic.

7. The clamp assembly of claim 1 wherein the left side portion or right side portion further comprise a pattern of alternating single and double spikes.

8. The clamp assembly of claim 7 further comprising a plurality of protrusions on the back side of the left side portion to provide depth for the extruded walls.

9. The clamp assembly of claim 1, manufactured by injection molding or 3D printing techniques.

10. The clamp assembly of claim 9 wherein the mold for injection molding is made of aluminum or steel.

11. A one-piece clamp assembly for securing a window covering comprising:
a left side portion further comprising:
a plurality of horizontal rounded extrusions;
a vertical rounded extrusion; and
a plurality of extruded walls;
a right side portion further comprising;
a plurality of horizontal connecting holes to receive the horizontal rounded extrusions from the left side portion;
a vertical connecting hole to receive the vertical rounded extrusion; and
a plurality of spikes to engage with the extruded walls of the left side portion; and
a hinge portion connecting the left side portion and right side portion;
wherein the one-piece clamp assembly is made of a one-piece material;
wherein the one-piece clamp assembly is configured to be in an open position and a closed position;
wherein in the closed position, the rounded extrusions mate with the respective connecting holes and the extruded walls mate with the respective spikes on the opposite side, to form a secure connection, whereby the window covering is secured therein between the left side portion and the right side portion.

12. The clamp assembly of claim 11 wherein each rounded extrusion further comprises a left and right leg and a rounded head such that, when pinched, the head creates a rounded extrusion.

13. The clamp assembly of claim 11 wherein the window covering is a window curtain or a vertical blind.

14. The clamp assembly of claim 11 wherein the hinge portion further comprises a connecting slot to enable the clamp assembly to fasten to a head rail fastener of the window covering.

15. The clamp assembly of claim 11, made from a single material selected from a list consisting of aluminum, steel, polypropylene and plastic.

16. The clamp assembly of claim 11 wherein the left side portion or right side portion further comprises a pattern of alternating single and double spikes.

17. The clamp assembly of claim 16 further comprising a plurality of protrusions on the back side of the left side portion to provide depth for the extruded walls.

18. The clamp assembly of claim 11, manufactured by injection molding or 3D printing techniques.

19. The clamp assembly of claim 18 wherein the mold for injection molding is made of aluminum or steel.
